(19) United States
(12) Patent Application Publication
(10) Pub. No.: US 2007/0054053 A1
(43) Pub. Date: Mar. 8, 2007

(54) Thermosetting paint, methods for making and using the same

(75) Inventors: Chi-Chuang Ho, Tu-Cheng (TW); Bor-Yuan Hsiao, Tu-Cheng (TW); Chuan-De Huang, Tu-Cheng (TW); Sheng-Hsi Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/472,967

(22) Filed: Jun. 21, 2006

(30) Foreign Application Priority Data
Sep. 5, 2005 (CN) 200510037137.5

(51) Int. Cl. B05D 3/12; C08G 18/62

(52) U.S. Cl. 427/355; 427/372.2; 427/421.1; 427/430.1; 524/545

(57) ABSTRACT

The present invention provides a thermosetting paint including a fluorine substituted polymethyl methacrylate-silicon resin with a percentage by weight in the range from 30 to 60, pigment particles dispersed therein with a percentage by weight in the range from 4 to 30 and residual solvent. A molecular structural formula of the fluorine substituted polymethyl methacrylate-silicon resin is as below: 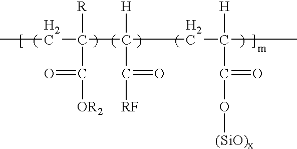
wherein “R”, “R₂” represents alkyl chains with carbon atomic number of 1 to 4, x represents 1 to 3, and m represents 83 to 277. The present invention also provides methods for making and using the thermosetting paint.

### TECHNICAL FIELD

The present invention relates to a thermosetting paint and related methods for making and using the thermosetting paint.

### DESCRIPTION OF RELATED ART

Paint is widely used for vehicle, furniture and electrical appliances. It is thus necessary for paint to be hard and smooth with good transparency whilst also having attractive color and appearance.

Conventionally, paint coating is comprised of a primer coating and a top lacquer coating. The primer coating is directly attached onto a surface of a substrate to be coated, and provides color whilst sealing the substrate and enhancing the adhesion between the substrate and the lacquer coating. The top lacquer coating is usually a transparent natural paint or a metallic paint, which matches the primer coating to give the whole paint coating an attractive high gloss. The paint coating is manufactured by the following steps: cleaning the surface of a substrate to be coated in order to get rid of dust, grease stains, etc thereon; mixing a primer uniformly; spraying the primer onto the surface of the substrate to form a primer coating; drying the primer coating at room temperature for 10 to 20 minutes; doping a top lacquer with a special curing agent and mixing the top lacquer and the curing agent uniformly; spraying the mixed curing agent and top lacquer onto the primer coating to form a top lacquer coating; airing for 10 to 15 minutes; and putting the coated substrate into an oven at about 50 to 60 centigrade degrees for about an hour so as to get desired paint coating.

However, the conventional paint coating has disadvantages such as poor dirt resistance, poor waterproofing and low durability. It is prone to becoming dirty and to losing its original gloss after a long period of exposure to the elements.

Therefore, a heretofore-unaddressed need exists in the industry to address the aforementioned deficiencies and inadequacies.

### SUMMARY

One preferred embodiment of the present invention provides a thermosetting paint, which includes a fluorine substituted polymethyl methacrylate-silicon resin with a percentage by weight between 30 and 60, pigment particles dispersed therein with a percentage by weight between 4 and 30, and residual solvent. A molecular structural formula of the fluorine substituted polymethyl methacrylate-silicon resin is as below: 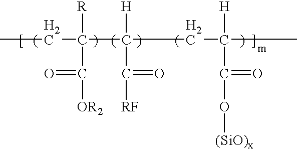
wherein “R”, “R₂” represents alkyl chains with carbon atomic number of 1 to 4, x represents 1 to 3, and m represents 83 to 277.

Another preferred embodiment of the present invention provides a method for making the thermosetting paint, which includes the following steps: adding a fluorine substituted polymethyl methacrylate-silicon resin with a percentage by weight between 30 and 60 and pigment particles with a percentage by weight between 4 and 30 in turn into a reactor, the reactor being pre-loaded with residual solvent, thereby forming a mixture; stirring the mixture to make it homogenous, thus forming a thermosetting paint.

In another preferred embodiment of the present invention a method for using the thermosetting paint is provided which includes the following steps: coating the thermosetting paint onto a workpiece; and curing it with heat, thus forming a thermosetting paint coating.

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention.

FIG. 1 is an atomic force microscopy (AFM) image of a thermosetting paint coating in accordance with a first preferred embodiment; and

FIG. 2 is an AFM image of a thermosetting paint coating in accordance with a second preferred embodiment.

### DETAILED DESCRIPTION OF PREFERRED EMBODIMENTS

The present invention provides a thermosetting paint, which comprises a fluorine substituted polymethyl methacrylate-silicon resin with a percentage by weight between 30 and 60, pigment particles with a percentage by weight between 4 and 30 dispersed in the resin, and residual solvent. It is preferable that the percentage of the fluorine substituted polymethyl methacrylate-silicon resin should be in the range from 35 to 50, and that of the pigment particles should be in the range from 5 to 20. Particle size of the pigment particles can be less than or equal to 191.4 nanometers. A molecular structural formula of the fluorine substituted polymethyl methacrylate-silicon resin is as below: 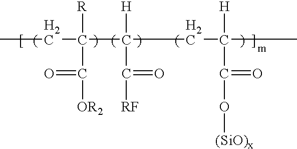
wherein “R”, “R₂” represents alkyl chains with carbon atomic number from 1 to 4, x represents 1 to 3, and m represents 83 to 277. The “R” group is substituted by a fluorine atom. The fluorine substituted polymethyl methacrylate-silicon resin is provided by DuPont etc.

The pigment particles are nano powder made from carbon black ground by a high speed ball grinding machine, which has a grain size of less than or equal to 191.4 nanometers.

The solvent of the embodiment can be chosen from one or more of the following solvents: xylene, toluene, 1-butanol, butyl acetate, 2-ethoxyethyl acetate etc. A mixed solvent of xylene, toluene, 1-butanol, butyl acetate and 2-ethoxyethyl acetate with a volume ratio of 6:9:1:2:2 is preferable.

The present invention also provides a method for making the thermosetting paint, which comprises the following steps: first of all, a fluorine substituted polymethyl methacrylate-silicon resin with a percentage by weight in the range from 30 to 60 and pigment particles with a percentage by weight in the range from 4 to 30 being fed in turn into a reactor, which contains predetermined amounts of residual solvent, thus forming a mixture; secondly, stirring the mixture until it is homogenous, thereby forming a thermosetting paint. It is preferable to stir the mixture using a stirring rod. When the solvent occupies a relatively large proportion of the total volume while the total volume of the mixture is not in itself too large, electromagnetic mixing or ultrasonic vibration mixing methods can also be used. The total amount of the mixture determines the time of stirring, which can be in the range from several hours to more than one day.

The present invention also provides a method for using the thermosetting paint, which comprises the following steps: first of all, the thermosetting paint obtained above being coated onto a workpiece. Then, curing it with heat using a lower temperature, preferably from 60 to 80 degrees centigrade, for about 30 to 50 minutes. The coating method can be spraying, dip-coating or spread coating. Different coating methods can give different appearances to the paint coating. The heating method can be practiced in an oven or with a hot-air drying method. After undergoing a predetermined period of baking, a finished thermosetting paint coating is obtained.

The thermosetting paint coating obtained has fluorine elements with a strong polarity, which are incompatible with the resin therein. Furthermore, specific weight of the fluorine elements are lower than that of the resin, therefore the fluorine elements will float outside of the resin during polymerization, thus forming a fluorine-containing surface with pin-like structures over the resin. Since the fluorine-containing surface has lower interfacial tension than the resin, it makes the thermosetting paint coating more waterproof.

In the preferred embodiment, pigment particles with an average grain size less than or equal to 191.4 nanometers are each coated by the resin and dispersed uniformly in the resin after being heated. The pigment particles form micro-protuberances on the resin. The micro-protuberances are capable of preventing dirt from attaching onto the resin. Even when dirt falls on the resin, water, for example rain water, will wash the dirt out easily to keep the resin clean, in this way, the thermosetting paint coating will last for a long time whilst also keeping its gloss.

Therefore, the paint coating formed by the thermosetting paint of the preferred embodiment has structures similar to those that in the nature can cause a “lotus flower effect”. “Lotus flower effect” means structures of similar to those of the leaves of a lotus flower which give them dirt resistance and waterproof properties. Therefore, it has advantages of having good dirt resistance, being waterproof, and possessing long durability and a high gloss finish.

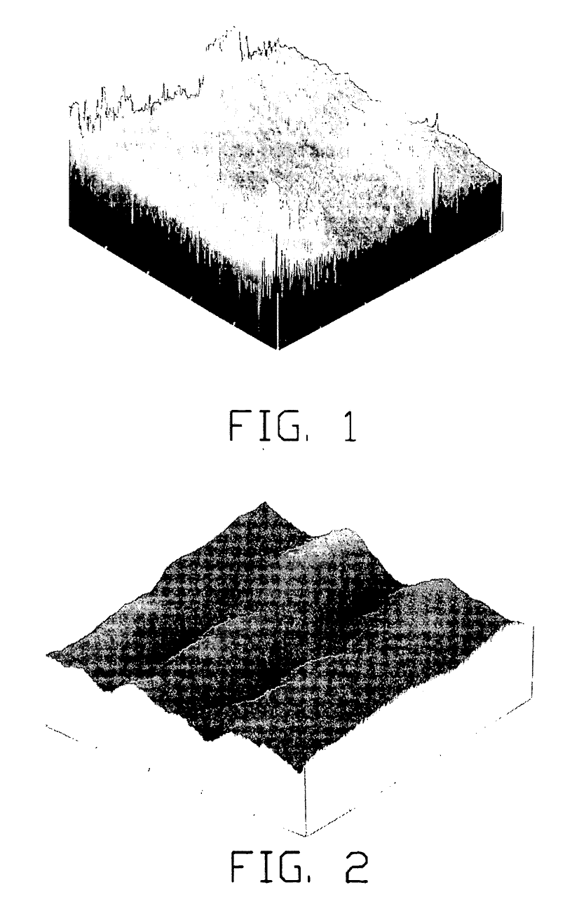

A thermosetting paint of a first preferred embodiment of the present invention is as below. A fluorine substituted polymethyl methacrylate-silicon resin with a percentage by weight of 35 and pigment particles with a percentage by weight of 8 are added in turn into a reactor which contains predetermined amounts of xylene and toluene therein to form a mixture. The pigment particles have a grain size of about 137.0 nanometers. The mixture can then be stirred for about 5 hours to make it homogenous, thereby forming a thermosetting paint. Spraying the thermosetting paint obtained thereabove onto a workpiece, and putting the workpiece in an oven to be heated at 60 degrees centigrade for 50 minutes to get a first thermosetting paint coating. FIG. 1 shows an atomic force microscopy (AFM) image of the first thermosetting paint coating.

A thermosetting paint of a second preferred embodiment of the present invention is as follows. A fluorine substituted polymethyl methacrylate-silicon resin with a percentage by weight of 45 and pigment particles with a percentage by weight of 5 are added in turn into a reactor which contains a pre-mixed solvent of xylene, toluene, 1-butanol, butyl acetate and 2-ethoxyethyl acetate with a volume ratio of 6:9:1:2:2 therein, to form a mixture. The pigment particles have a grain size of 191.4 nanometers. The mixture can then be stirred for about 5 hours to make it homogenous, thereby forming a thermosetting paint. Spaying the thermosetting paint obtained thereabove onto a workpiece, and putting the workpiece in an oven to be heated at 60 degrees centigrade for 50 minutes will produce a second thermosetting paint coating. FIG. 2 shows an AFM image of the second thermosetting paint coating.

In FIGS. 1 and 2, pin-like structures floating outside of the paint coating are fluorine elements, micro-protuberances below the pin-like structures are nano-carbon black particles coated by the resin. These structures are capable of producing a “lotus flower effect”, which can resist dirt and waterproof. Comparing the two images, when the grain size of the pigment particles is roughly 137.0 nanometers, those structures that can produce a “lotus flower effect”, such as pin-like structures and micro protuberances, are pronounced. When the grain size of pigment particles is 191.4 nanometers, those structures are less prominent. That is to say, grain size of less than or equal to 191.4 nanometers is favorable for dirt resistance and has better waterproofing and durability.

Mechanical property tests to the paint coatings obtained above gives the following results: they have a viscosity of up to 5B and a hardness up to 1H, where 5B is a measurement on the 3M peeling test, and 1H is a grade on the standard measurement of hardness for pencils. Furthermore, gloss degree test gets a result of above 90 degrees. Generally, when gloss degree is higher than 80 degrees, the coating can take on a mirror-like shine. Therefore, the paint coatings made by the thermosetting paint coating of the present invention reaches the standard of the art.

While certain embodiments of the present invention have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A thermosetting paint, comprising:
a fluorine substituted polymethyl methacrylate-silicon resin with a percentage by weight in the range from 30 to 60, pigment particles with a percentage by weight in the range from 4 to 30 dispersed in the resin, and residual solvent, a molecular structural formula of the fluorine substituted polymethyl methacrylate-silicon resin being as below: 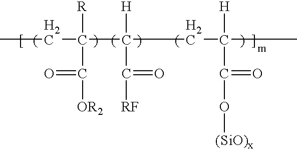
wherein “R”, “R₂” represents alkyl chains with carbon atomic number of 1 to 4, x represents 1 to 3, and m represents 83 to 277.

2. The thermosetting paint as claimed in claim 1, wherein a percentage of the fluorine substituted polymethyl methacrylate-silicon resin by weight is in the range from 35 to 50.

3. The thermosetting paint as claimed in claim 1, wherein a percentage of the pigment particles is in the range from 5 to 20.

4. The thermosetting paint as claimed in claim 1, wherein the pigment particles are made from carbon black.

5. The thermosetting paint as claimed in claim 1, wherein a grain size of the pigment particles is less than or equal to 191.4 nanometers.

6. The thermosetting paint as claimed in claim 5, wherein a grain size of the pigment particles is less than or equal to 137.0 nanometers.

7. The thermosetting paint as claimed in claim 1, wherein the solvent is chosen from at least one of the following solvents: xylene, toluene, 1-butanol, butyl acetate and 2-ethoxyethyl acetate.

8. A method for making a thermosetting paint, comprising the following steps:
adding a fluorine substituted polymethyl methacrylate-silicon resin with a percentage by weight in the range from 30 to 60 and pigment particles with a percentage by weight in the range from 4 to 30 in turn into a reactor which contains residual solvent, thereby forming a mixture; and
stirring the mixture to make it homogenous, thereby forming the thermosetting paint.

9. The method for making a thermosetting paint as claimed in claim 8, wherein a grain size of the pigment particles is measured in nanometers.

10. The method for making a thermosetting paint as claimed in claim 9, wherein a grain size of the pigment particles is less than or equal to 191.4 nanometers.

11. The method for making the thermosetting paint as claimed in claim 8, wherein the mixture is stirred using a stirring rod, an electromagnetic mixing method or an ultrasonic vibration mixing method.

12. A method for using the thermosetting paint of claim 1, comprising the steps of:
coating the thermosetting paint onto a workpiece; and
heating the paint to cure it, thus forming a thermosetting paint coating on the workpiece.

13. The method for using the thermosetting paint as claimed in claim 12, wherein the thermosetting paint is coated by a spraying, dip-coating or spread coating method.

14. The method for using the thermosetting paint as claimed in claim 12, wherein the heating step is at a temperature ranging from 60 to 80 degrees centigrade.

15. The method for using the thermosetting paint as claimed in claim 12, wherein the heating step lasts for 30 to 50 minutes.

16. The method for using the thermosetting paint as claimed in claim 12, wherein the heat step is performed in an oven or by a heated-air drying treatment.
